(19) United States
(12) Patent Application Publication
(10) Pub. No.: US 2025/0256314 A1
(43) Pub. Date: Aug. 14, 2025

(54) LITHIUM ROLLING APPARATUS AND LITHIUM ROLLING METHOD USING SAME

(71) Applicant: SOLUM ADVANCED MATERIALS CO., LTD., Gangneung-si, Gangwon-do (KR)

(72) Inventor: Hyo Tae JEONG, Gangneung-si, Gangwon-do (KR)

(21) Appl. No.: 18/725,613

(22) PCT Filed: Dec. 29, 2022
(86) PCT No.: PCT/KR2022/021595

§ 371 Date: Jan. 20, 2025

(30) Foreign Application Priority Data
Dec. 30, 2021 (KR) 10-2021-0192657
Dec. 30, 2021 (KR) 10-2021-0192658

(51) Int. Cl. B21B 1/24; B21B 15/00; B21B 37/52; B21B 45/02; H01M 4/04

(52) U.S. Cl. CPC B21B 1/24; B21B 37/52; B21B 45/0251; H01M 4/0435; B21B 2015/0057; B21B 2015/0064; B21B 45/0242

(57) ABSTRACT

The present disclosure relates to a lithium rolling apparatus for forming a lithium foil by rolling a lithium sheet and includes a first roll which contacts a first surface of the lithium sheet; a second roll which contacts a second surface of the lithium sheet; and a first conveyor device disposed at a rear side of the first roll and the second roll, including a belt which transports the lithium foil while controlling tension applied to the lithium foil by surface-contacting at least a part of the second surface of the lithium foil.

### TECHNICAL FIELD

The present disclosure relates to a lithium rolling apparatus and a lithium rolling method using the same, and more specifically to the lithium rolling apparatus for forming a lithium foil utilized as a negative electrode material of a lithium secondary battery and the lithium rolling method using the same.

### BACKGROUND ART

A lithium ion secondary battery is a secondary battery that has high charge and discharge capacities and is capable of high output. The lithium ion secondary battery is mainly used as a power supply for a mobile electronic device and has recently been expected to be used as a power supply for an electric vehicle. The lithium ion secondary battery has active materials capable of adsorbing and releasing lithium at the positive and negative electrodes, respectively. In addition, the lithium ion secondary battery operates by movement of charge carriers, lithium ions, through the electrolyte liquid between the electrodes.

According to necessity, lithium ions are introduced into an object such as the active material, an electrode, the lithium ion secondary battery, etc., and the introduction of the lithium ions into the object is hereinafter referred to as lithium doping. Such lithium doping method includes an electrical doping method, direct target doping method, etc.

On the other hand, lithium is a relatively soft metal compared to other metals, and excessive deformation occurs in a lithium sheet during rolling. Therefore, shape collapse or damage is likely to occur in the lithium sheet after rolling. This is called a sticking phenomenon, and in fact, for this reason, it is not easy to manufacture the lithium sheet which is thin and has a good shape at the same time, by rolling.

The cause of deformation of the lithium sheet is that during rolling, a large force is applied to a lithium raw foil from a rolling roll, and when a shear plastic deformation by a frictional force with the material exceeds a yield strength of the material, the lithium raw foil is press-bonded onto the roll. If the lithium raw foil is press-bonded onto the roll, it is difficult to remove the lithium foil from the roll after rolling without deformation or damage. Therefore, a product lithium foil is prone to shape collapse or damage.

In order to solve the above-mentioned problems, a rolling method has been proposed in some documents for manufacturing the product lithium sheet for a cathode active material of lithium batteries by applying an organic solvent for an electrolytic liquid to the surface of the roll to reduce frictional force and prevent press-bonding. Here, the organic solvent can function as a lubricant, thereby suppressing the damage to the lithium foil. Also, a method of rolling by stacking a resin film on the lithium sheet is being suggested.

However, there was a problem in that it was difficult to control the sticking phenomenon of the material sticking to the rolling roll when manufacturing the lithium foil just by using the lubricant and the resin film. Further, when transporting a very thin lithium foil, a tension control applied to the lithium foil is sensitive. Therefore, the lithium foil may be torn even if a slightly strong tension is applied, making it difficult to manufacture the thin lithium foil with a thickness of 100 μm or less through a rolling process.

### DISCLOSURE

### Technical Problem

The present disclosure was designed to address the above requirements, and aims to provide a lithium rolling device configured to produce a very thin and wide lithium foil which is used as a negative electrode material for lithium secondary batteries, without deformation or damage to the lithium foil, and a lithium rolling method using the same. However, these problems are exemplary and do not limit the scope of the present disclosure.

### Technical Solution

According to an embodiment of the present disclosure, a lithium rolling apparatus for forming a lithium foil by rolling a lithium sheet is provided. The lithium rolling apparatus may include a first roll which contacts a first surface of the lithium sheet; a second roll which contacts a second surface of the lithium sheet; and a first conveyor device disposed at a rear side of the first roll and the second roll, including a belt which transports the lithium foil while controlling tension applied to the lithium foil by surface-contacting at least a part of the second surface of the lithium foil.

The lithium rolling apparatus may include a guide roll formed at a position contacting the first surface of the lithium foil on the first conveyor device so that the lithium foil can be transported in a flat manner when the lithium foil is transported by the first conveyor device.

The lithium rolling apparatus may include a second conveyor device disposed at an upper part of the first conveyor device, which contacts the first surface of the lithium foil and transports the lithium foil, wherein the first conveyor device and the second conveyor device may be driven at a same speed.

The lithium rolling apparatus may include a third conveyor device disposed at a front side of the first roll and the second roll for transporting the lithium sheet while contacting at least any part of the second surface of the lithium sheet, wherein driving speed of the third conveyor device may be controlled to be equal to or slower than driving speed of the first conveyor device.

The lithium rolling apparatus may further include a fourth conveyor device disposed at an upper part of the third conveyor device, which contacts the first surface of the lithium sheet and transports the lithium sheet,
wherein the third conveyor device and the fourth conveyor device may be driven at a same speed.

The lithium rolling apparatus may include a lubricant supply part which sprays lubricant on at least any one surface of the lithium sheet before being rolled by the first roll and the second roll to suppress a sticking phenomenon.

The lithium rolling apparatus is characterized in that the first roll, the second roll and the belt may include a polymer material, and the polymer material may include any one of polyethylene, polypropylene, vinylidene, polyolefin, and polyester.

The lithium rolling apparatus is characterized in that a resin film may be further interposed on at least any one surface of the lithium sheet contacting any one of the first roll and the second roll to prevent a sticking phenomenon.

The lithium rolling apparatus is characterized in that a width of the belt of the first conveyor device may be greater than a width of the lithium foil, and the lithium foil may be transported at a same speed as the belt by a driving force of the belt in a surface-contact state.

According to an embodiment of the present disclosure, a lithium rolling method for forming a lithium foil by rolling a lithium sheet may be provided. The lithium rolling method may include a step of forming a lithium foil by rolling using a first roll contacting a first surface of a lithium sheet and a second roll contacting a second surface of the lithium sheet; and a step of transporting the lithium foil with a first conveyor device disposed at a rear side of the first roll and the second roll while controlling tension applied to the lithium foil by surface-contacting at least any part of a second surface thereof with a belt provided on the first conveyor device.

The lithium rolling method is characterized in that when the lithium foil is transported by the first conveyor device by a guide roll formed at a position contacting the first surface of the lithium foil on the first conveyor device or by a second conveyor device, tension applied on the lithium foil may be controlled, and the lithium foil may be transported in a flat manner.

According to an embodiment of the present disclosure, a lithium rolling apparatus for forming a lithium foil by rolling a lithium sheet is provided. The lithium rolling apparatus may include a conveyor device for transporting and rolling the lithium sheet; and a roll disposed at an upper part of the conveyor device for rolling the lithium sheet; wherein the conveyor device may include a belt surface-contacting at least a part of a lower surface of the lithium sheet for rolling and transporting the lithium sheet while controlling tension applied on the lithium sheet, and a support part for supporting the lithium sheet.

The lithium rolling apparatus is characterized in that at least two or more rolling mills each comprising a unit of the conveyor device and the roll may be disposed continuously, and among at least two or more of the rolling mills, a driving speed of the rolling mill disposed at a rear side may be controlled to be equal to or faster than a driving speed of the rolling mill disposed at a front side.

The lithium rolling apparatus is characterized in that among at least two or more of the rolling mills, a diameter of the rolling mill disposed at the rear side may be equal to or smaller than a diameter of the rolling mill disposed at the front side.

The lithium rolling apparatus is characterized in that a plurality of the rolls may be provided on the conveyor device, and a diameter of the roll disposed at a rear side of the conveyor device may be equal to or smaller than a diameter of the roll disposed at the front side of the conveyor device.

The lithium rolling apparatus may include a lubricant supply part which sprays lubricant on at least any one surface of the lithium sheet before being rolled by the roll and the conveyor device to suppress a sticking phenomenon.

The lithium rolling apparatus is characterized in that a resin film may be further interposed on at least any one surface of the lithium sheet contacting any one of the roll and the conveyor device to prevent a sticking phenomenon.

The lithium rolling apparatus is characterized in that a width of the belt of the conveyor device may be greater than a width of the lithium foil, and the lithium foil may be transported at a same speed as the belt by a driving force of the belt in a surface-contact state.

The lithium rolling apparatus is characterized in that the roll and the belt may include a polymer material, and the polymer material may include any one of polyethylene, polypropylene, vinylidene, polyolefin, and polyester.

### Effect of the Invention

According to an embodiment of the present disclosure as described above, a lithium foil with a thickness of 100 μm or less can be implemented using the lithium rolling apparatus configured to form the lithium foil used as a negative electrode material of the lithium secondary battery. However, the scope of the present disclosure is not limited by these effects.

### BRIEF DESCRIPTION OF THE DRAWINGS

FIG. 1 is a schematic diagram illustrating a structure of a lithium rolling apparatus according to an embodiment of the present disclosure.

FIGS. 2 and 3 are a cross-sectional view and a top view schematically illustrating a structure of a conveyor device provided in the lithium rolling apparatus shown in FIG. 1.

FIGS. 4 and 5 are cross-sectional views schematically illustrating a structure of a lithium rolling apparatus according to another embodiment of the present disclosure.

FIG. 6 is a schematic diagram illustrating a structure of a lithium rolling apparatus according to another embodiment of the present disclosure.

FIGS. 7 and 8 are a cross-sectional view and a top view schematically illustrating a structure of a conveyor device provided in the lithium rolling apparatus shown in FIG. 6.

FIGS. 9 and 10 are cross-sectional views schematically illustrating a structure of a conveyor device of a lithium rolling apparatus according to another embodiment of the present disclosure.

### MODE FOR INVENTION

Hereinafter, the present disclosure will be described in detail by explaining embodiments of the present disclosure with reference to the attached drawings.

Various embodiments of the present disclosure may be embodied in many different forms and should not be construed as being limited to the example embodiments set forth herein. Rather, these example embodiments of the disclosure are provided so that this disclosure will be thorough and complete and will convey inventive concepts of the disclosure to those skilled in the art. Embodiments of the disclosure are described herein with reference to schematic illustrations of idealized embodiments (and intermediate structures) of the disclosure.

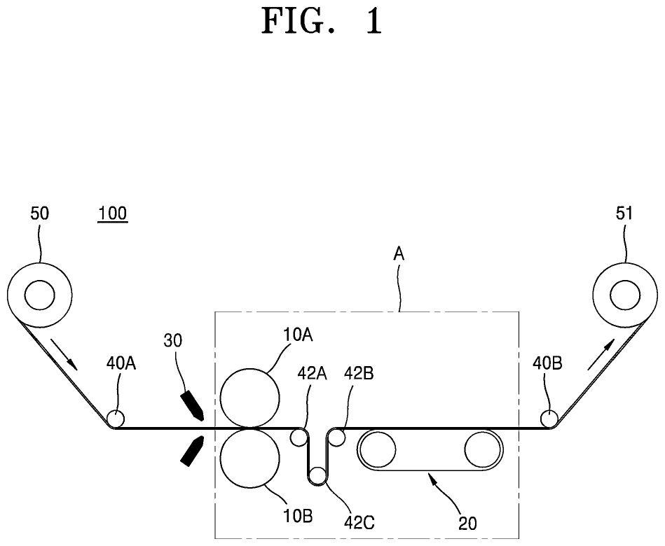

FIG. 1 is a schematic diagram illustrating a structure of a lithium rolling apparatus according to an embodiment of the present disclosure.

Referring to FIG. 1, the lithium rolling apparatus 100 according to an embodiment of the present disclosure has a rolling part which forms a lithium foil by rolling a lithium sheet between a first roll 10A and a second roll 10B. With respect to the rolling part, a lubricant supply part 30 configured to spray lubricant on the surface of the lithium sheet is placed at a front side where the lithium sheet is inserted.

While the first roll 10A and the second roll 10B are illustrated to be in a same size, the first roll 10A and the second roll 10B may be disposed having different diameters according to necessity. In this case, by controlling power supplied to each of the first roll 10A and the second roll 10B to control rotation linear velocity of the first roll 10A and the second roll 10B to be the same, a shear stress applied to a lithium sheet 60 can be controlled to roll the lithium sheet 60. Here, a specific power control of the rolling rolls is already known in the art and will not be described in detail.

The form of lubricant supply part 30 may be in a form of applying droplets, spraying the lubricant in a form of a spray, or in a form of applying the lubricant directly to a surface of the lithium sheet 60 using a brush, etc. The lubricant may be any of the following organic solvents, for example, pentane, hexane, heptane, octane, nonane, decane, ethyl methyl carbonate, propylene carbonate, dimethyl carbonate, diethyl carbonate, fluoromethyl methyl carbonate, difluoromethyl methyl carbonate, 2, 2, 2-trifluoroethyl methyl carbonate, bis(2,2,2-trifluoroethyl) carbonate, acetonitrile, propionitrile, butyronitrile, acrylonitrile, dimethoxymethane, 1, 2-dimethoxyethane, tetrahydrofuran, 2-methyl tetrahydrofuran, 1, 2-dioxane, 1,3-dioxane, 1,4-dioxane, 2, 2-dimethyl-1,3-dioxolane, 2-methyl tetrahydropyran, 1, 3-dioxolane, N, N-dimethyl acetamide, isopropyl isocyanate, N-propyl isocyanate, chloromethyl isocyanate, dimethyl acetal, diethyl ether, methyl isobutyl ketone, 1, 2-dimethoxyethane, 1,2-diethoxyethane, methyl formate, ethyl formate, propyl formate, methyl acetate, ethyl acetate, butyl acetate, propyl acetate, isopropyl acetate, isobutyl acetate, methyl propionate, vinyl acetate, methyl acrylate, methyl methacrylate, glycidyl methyl ether, epoxy butane, 2-ethyl oxirane, oxazole, 2-ethyloxazole, oxazoline, 2-methyl-2-oxazoline, acetone, methyl ethyl ketone, acetic anhydride, 1-nitropropane, 2-nitropropane, furan, γ-butyrolactone, thiophene, pyridine, 1-methylpylorizine, N-methylmorpholine, etc.

The lithium sheet refers to a pre-extruded lithium raw foil, for example, from about 150 to 1000 μm thick. Further, the lithium sheet also refers to a pure lithium plate or an alloy plate containing lithium. Using the lithium rolling apparatus according to an embodiment of the present disclosure, the lithium sheet can be rolled to form a lithium foil having a thickness of 100 μm or less.

The lithium sheet is wound around a reel 50, then unwound and supplied to the rolling part. After rolling, the lithium sheet is wound around a reel 51 disposed at a position opposite to the reel 50. A plurality of tension rolls 40A, 40B are formed on a part of the lithium rolling apparatus 100 to adjust the speed of the lithium sheet, appropriately control the tension, and to ensure that the lithium sheet is would onto the reel 51 in a flat manner. The plurality of tension rolls 40A, 40B can be simply positioned in one direction to control the tension of the lithium sheet, or they can be arranged in a zigzag shape on both sides of the lithium sheet to control the tension of the lithium sheet more efficiently.

However, since lithium is a relatively soft metal compared to other metals, if the tension is controlled using only the tension rolls 40A, 40B, there is a high possibility that the lithium sheet may be torn or deformed.

In order to solve this problem, the present disclosure controlled the tension applied to the lithium foil using a conveyor device 20 in order to prevent a deformation or damage of the lithium foil rolled by the rolling part. Hereinafter, configuration of a conveyor belt 20 and a lithium rolling method will be described in detail with reference to the drawings.

Further, when controlling the tension using the conveyor device 20, if the tension is applied between the rolling roll and a belt provided on the conveyor device 20, the lithium foil receives the tension directly and there is a high possibility of a plate fracture or abnormality in surface quality. In order to solve this problem, it is important to configure a device (hereinafter referred to as a dancer roll) which adjusts the tension between the rolling roll and the belt so that the lithium foil does not receive direct tension between the rolling roll and the conveyor device 20.

As shown in FIG. 1, by additionally configuring dancer rolls 42A, 42B, 42C between rolling rolls 10A, 10B and the conveyor device 20, it is possible to control so that no direct tension is applied to the lithium foil. Hereinafter, the dancer rolls 42A, 42B, 42C are already known in the art and will not be described in detail.

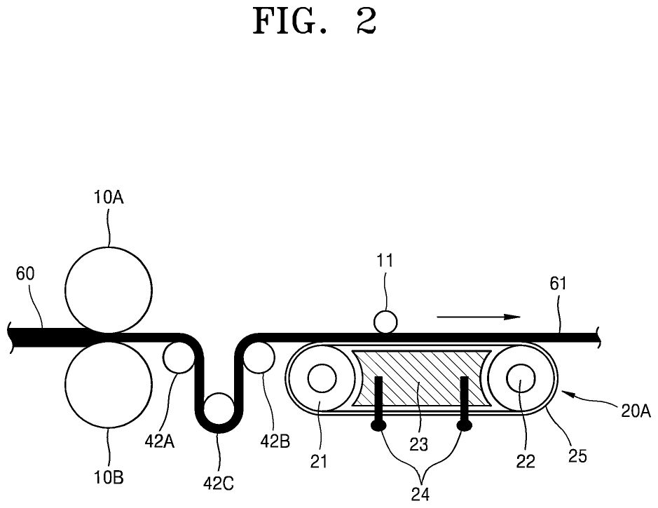

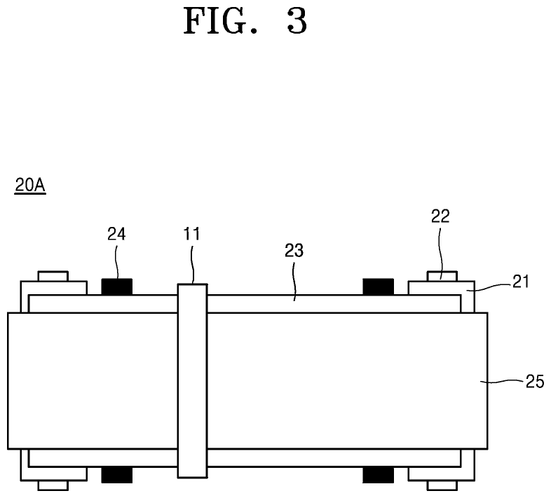

FIGS. 2 and 3 are a cross-sectional view and a top view schematically illustrating a structure of a conveyor device provided in the lithium rolling apparatus shown in FIG. 1. Here, FIG. 2 is an enlarged view of a portion A of FIG. 1, and FIG. 3 is a top view of the conveyor device in FIG. 2.

Referring to FIGS. 2 and 3, the lithium sheet 60 is rolled into a lithium foil 61 by the first roll 10A contacting a first surface of the lithium sheet 60 and the second roll 10B contacting a second surface of the lithium sheet 60. Here, a first conveyor device 20A disposed at a rear side of the first roll 10A and the second roll 10B may be included to transport the lithium sheet 60 contacting at least any part of the second surface of the lithium sheet 60 while controlling the applied tension.

In an example, the lithium rolling apparatus 100 according to an embodiment of the present disclosure can control the tension applied on the lithium foil 61 with a single first conveyor device 20A. In this case, when one end of the lithium foil 61 is rolled by the first roll 10A and the second roll 10B, it may be curled up to either side. In order to solve this problem, the present disclosure further includes a guide roll 11 which contacts a first surface of the lithium foil 61 opposite to the first conveyor device 20A, that is, the guide roll 11 that contacts any part of the upper surface of the lithium foil 61. The guide roll 11 is only involved in transporting the lithium foil 61, and it is in close contact with the first conveyor device 20A while maintaining a constant gap so as not to affect the shape of the lithium foil 61.

The first conveyor device 20A may include a support part 23 for supporting the lithium foil 61, a belt 25 surrounding the support part 23 and contacting the lithium foil 61, and a driving part for driving the belt 25. Here, the driving part may include a drive roll 21 and a power unit 22 configured to rotate the drive roll 21.

Further, the first conveyor device 20A may include the belt 25, wherein at least a part of the belt 25 surface-contacts the second surface of the lithium foil 61, which transports the lithium foil 61 while controlling the tension applied on the lithium foil 61.

The belt 25 may be disposed to drive along an outer circumferential surface of the driving part, and the support part 23 is formed on the interior of the belt 25 to support the lithium foil 61. Here, on both sides of the support part 23, anchor parts 24 are formed to support to prevent interference with driving of the first conveyor device 20A. The support part 23 is formed to be approximately the same size as the diameter of the drive roll 21 of the first conveyor device 20A and closely contacts the belt 25 to prevent the lithium foil 61 from sagging.

A width of the belt 25 is greater than a width of the lithium foil 61, and the lithium foil 61 can be transported at the same speed as the belt 25 in a surface-contact state with the belt 25 by the driving force of the belt 25. If the width of the belt 25 is equal to or smaller than the width of the lithium foil 61, the tension applied on the lithium foil 61 is not adequately controlled, and a lithium sticking phenomenon may not be suppressed. Therefore, the width of belt 25 should always be formed to be greater than the width of the lithium foil 61.

A material of the belt 25 may include, for example, a polymer material. In addition, the same material can be used for the first roll 10A and the second roll 10B as the belt 25. Types of the polymer material may include any of polyethylene, polypropylene, vinylidene, polyolefin, and polyester, and any other material that has low adhesion to lithium and does not cause the lithium sticking phenomenon can be used.

The lithium foil 61 is transported along the belt 25 by resistance generated from a part of the belt 25 surface-contacting a lower surface of the lithium foil 61, and is finally wound on the reel 51. The reel 51 can be automatically rotated by a transporting force of the conveyor device 25 without a separate driving part.

Alternatively, the reel 51 be driven by a driving part provided on one side for winding the lithium foil 61.

Furthermore, as described above with reference to FIG. 1, if the lithium foil 61 is transported directly using the conveyor device 20, the tension may be applied to the lithium foil 61 directly, which may cause an abnormality in quality. Therefore, the dancer rolls 42A, 42B, 42C are provided after the first roll 10A and the second roll 10B to smoothly perform the transportation of the lithium foil 61 by the conveyor device 20.

Although not shown in the drawings, if the material of the first roll 10A and the second roll 10B is not made of a polymer, for example, in case of using a metallic material, the rolling may be performed without the sticking phenomenon of the lithium sheet 60 by further interposing a resin film on at least one side of the lithium sheet 60 that contacts either of the first roll 10A and the second roll 10B. The resin film may include, for example, any one of polyethylene, polypropylene, vinylidene, polyolefin, and polyester.

On the other hand, the lithium rolling apparatus 100 according to an embodiment of the present disclosure may be further applied with a conveyor device instead of the guide roll 11. This will be described later with reference to the drawings.

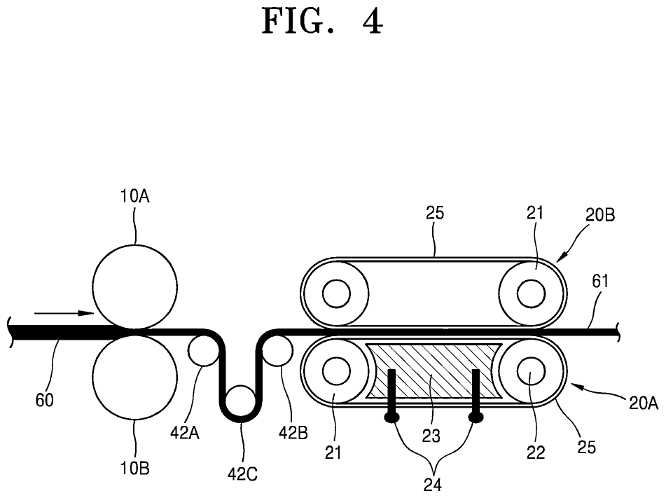

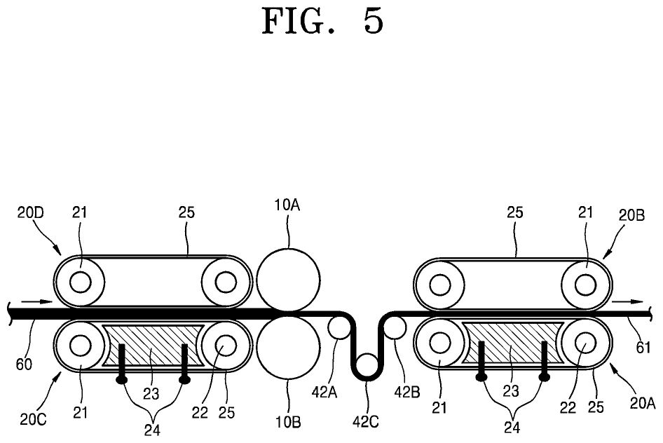

FIGS. 4 and 5 are cross-sectional views schematically illustrating a structure of a lithium rolling apparatus according to another embodiment of the present disclosure.

Referring to FIG. 4, the lithium rolling apparatus 100 may have a second conveyor device 20B formed on the first conveyor device 20A instead of the guide roll 11 in order to control the tension of the lithium foil 61 more effectively.

The structure of the second conveyor device 20B may be configured identically to the structure of the first conveyor device 20A. However, the support part 23 provided on the first conveyor device 20A may be omitted because the belt 25 of the second conveyor device 20B can apply a load uniformly over the entire upper surface of the lithium foil 61 with gravity.

Driving speed of the first conveyor device 20A and driving speed of the second conveyor device 20B should be equal, and should be controlled to be equal to or faster than the driving speed of the first roll 10A and the second roll 10B. Here, if size of any one of the first roll 10A and the second roll 10B is different, the driving speed of the first conveyor device 20A and the second conveyor device 20B may be controlled appropriately.

Referring to FIG. 5, the lithium rolling apparatus 100 includes a third conveyor device 20C having the same structure as the first conveyor device 20A at a front side of the rolling part for controlling the tension of the lithium sheet 60 as well as controlling the tension of the lithium foil 61. Here, the tension of the lithium sheet 60 can be controlled only with the third conveyor device 20C, but in order to control the tension of the lithium sheet more efficiently, a fourth conveyor device 20D which has a same structure as the second conveyor device 20B may be disposed on the third conveyor device 20C. The structures of the third conveyor device 20C and the fourth conveyor device 20D are the same as the structures of the first conveyor device 20A and the second conveyor device 20B, respectively, so detailed descriptions thereof will be omitted.

Driving speed of the third conveyor device 20C and driving speed of the fourth conveyor device 20D should be equal. Here, the driving speed of the third conveyor device 20C should be controlled to be equal to or slower than the driving speed of the first conveyor device 20A provided at the rear side of the first roll 10A and the second roll 10B. That is, the driving speed of the third conveyor device 20C, the rolling part (first roll 10A and second roll 10B), and the first conveyor device 20A should all be controlled equally. Alternatively, the driving speed of the third conveyor device 20C should be controlled to be slower than the driving speed of the first conveyor device 20A. In addition, the driving speed of the third conveyor device 20C should be controlled to be relatively slower than the driving speed of the rolling part (first roll 10A and second roll 10B).

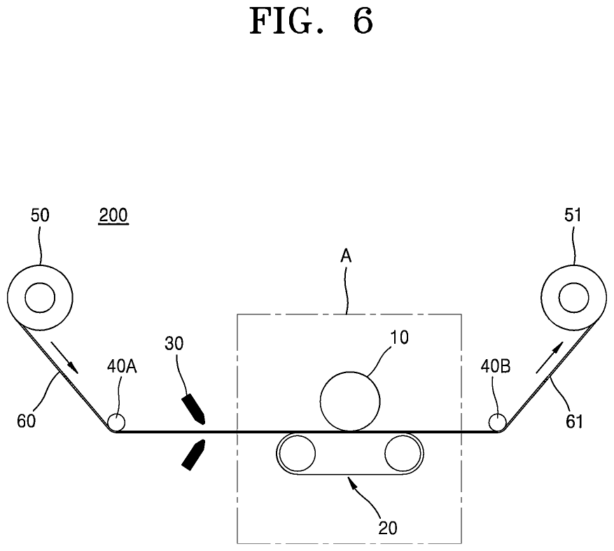

FIG. 6 is a schematic diagram illustrating a structure of a lithium rolling apparatus according to another embodiment of the present disclosure.

Referring to FIG. 6, a lithium rolling apparatus 200 according to an embodiment of the present disclosure includes a conveyor device 20 which transports and rolls a lithium sheet 60, and a roll 10 disposed on top of the conveyor device 20 which rolls the lithium sheet 60. The conveyor device 20 includes a belt (not shown), which is at least a part surface-contacted on a lower surface of the lithium sheet 60 and rolls and transports the lithium sheet 60 while controlling the tension applied on the lithium sheet 60. In addition, a lubricant supply part 30 is included, which sprays lubricant on at least one surface of the lithium sheet 60 before being rolled by the roll 10 and the conveyor device 20 to suppress a sticking phenomenon.

In the roll 10, by controlling power to control rotation linear velocity of a belt provided on the roll 10 and the conveyor device 20 to be the same, a shear stress applied to the lithium sheet 60 can be controlled to roll the lithium sheet 60. Here, a specific power control of the rolling rolls is already known in the art and will not be described in detail.

The form of lubricant supply part 30 may be in a form of applying droplets, spraying the lubricant in a form of a spray, or in a form of applying the lubricant directly to a surface of the lithium sheet using a brush, etc. The lubricant may be any of the following organic solvents, for example, pentane, hexane, heptane, octane, nonane, decane, ethyl methyl carbonate, propylene carbonate, dimethyl carbonate, diethyl carbonate, fluoromethyl methyl carbonate, difluoromethyl methyl carbonate, 2, 2, 2-trifluoroethyl methyl carbonate, bis(2,2,2-trifluoroethyl) carbonate, acetonitrile, propionitrile, butyronitrile, acrylonitrile, dimethoxymethane, 1, 2-dimethoxyethane, tetrahydrofuran, 2-methyl tetrahydrofuran, 1, 2-dioxane, 1,3-dioxane, 1,4-dioxane, 2, 2-dimethyl-1,3-dioxolane, 2-methyl tetrahydropyran, 1, 3-dioxolane, N, N-dimethyl acetamide, isopropyl isocyanate, N-propyl isocyanate, chloromethyl isocyanate, dimethyl acetal, diethyl ether, methyl isobutyl ketone, 1, 2-dimethoxyethane, 1,2-diethoxyethane, methyl formate, ethyl formate, propyl formate, methyl acetate, ethyl acetate, butyl acetate, propyl acetate, isopropyl acetate, isobutyl acetate, methyl propionate, vinyl acetate, methyl acrylate, methyl methacrylate, glycidyl methyl ether, epoxy butane, 2-ethyl oxirane, oxazole, 2-ethyloxazole, oxazoline, 2-methyl-2-oxazoline, acetone, methyl ethyl ketone, acetic anhydride, 1-nitropropane, 2-nitropropane, furan, γ-butyrolactone, thiophene, pyridine, 1-methylpylorizine, N-methylmorpholine, etc.

The lithium sheet is wound around a reel 50, then unwound and supplied to a rolling part. After rolling, the lithium sheet is wound around a reel 51 disposed at a position opposite to the reel 50. A plurality of tension rolls 40A, 40B are formed on a part of the lithium rolling apparatus 200 to adjust the speed of the lithium sheet, appropriately control the tension, and to ensure that the lithium sheet is would onto the reel 51 in a flat manner. The plurality of tension rolls 40A, 40B can be simply positioned in one direction to control the tension of the lithium sheet, or they can be arranged in a zigzag shape on both sides of the lithium sheet to control the tension of the lithium sheet more efficiently.

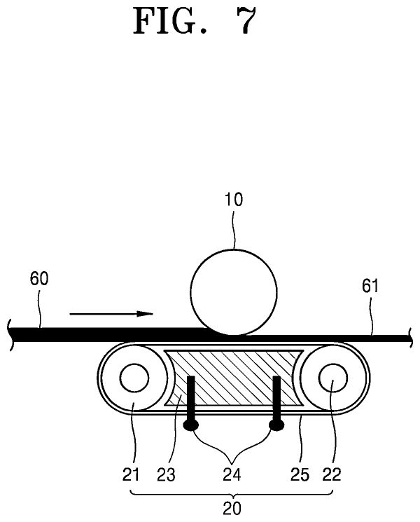

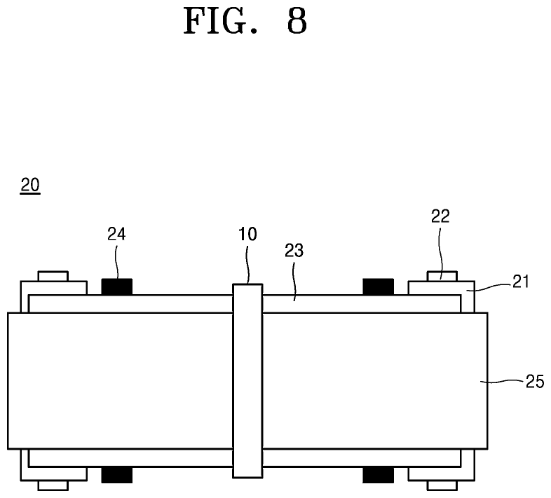

FIGS. 7 and 8 are a cross-sectional view and a top view schematically illustrating a structure of a conveyor device provided in the lithium rolling apparatus shown in FIG. 6. Here, FIG. 7 is an enlarged view of a portion A of FIG. 6, and FIG. 8 is a top view of the conveyor device in FIG. 6.

Referring to FIGS. 7 and 8, the lithium sheet 60 is rolled into a lithium foil 61 by the roll 10 contacting an upper surface of the lithium sheet 60 and the conveyor device 20 contacting a lower surface of the lithium sheet 60. Here, the conveyor device 20 may be in surface-contact with at least a part of the lower surface of the lithium sheet 60 or the lithium foil 61 to transport the lithium sheet 60 or the lithium foil 61 while controlling the tension applied thereon.

In an example, the lithium rolling apparatus 200 according to an embodiment of the present disclosure can control the tension applied on the lithium sheet 60 or the lithium foil 61 with the conveyor device 20. The conveyor device 20 is in close contact with the roll 10 while maintaining a constant gap to roll the lithium sheet 60. In order to perform a stable rolling, the conveyor device 20 may further include a support part 23 for supporting the lithium sheet 60 and a driving part for driving a belt 25. Here, the driving part may include a drive roll 21 and a power unit 22 configured to rotate the drive roll 21.

The belt 25 may be disposed to drive along an outer circumferential surface of the driving part, and the support part 23 is formed on the interior of the belt 25. Here, on both sides of the support part 23, anchor parts 24 are formed to support to prevent interference with driving the conveyor device 20. The support part 23 is formed to be approximately the same size as the diameter of the drive roll 21 of the conveyor device 20 and closely contacts the belt 25 to roll the lithium sheet 60. In addition, the support part 23 can prevent the lithium foil 61 from sagging downward while it is being transported.

A width of the belt 25 is greater than a width of the lithium sheet 60 or the lithium foil 61, and the lithium sheet 60 or the lithium foil 61 can be transported at the same speed as the belt 25 in a surface-contact state with the belt 25 by the driving force of the belt 25. The width of the lithium foil 61 may be equal to the width of the lithium sheet 60, or the lithium sheet 60 may be rolled so that the width of the lithium foil 61 is relatively greater than the width of the lithium sheet 60. Therefore, the width of belt 25 should be equal to or greater than the width of lithium foil 61. If the width of the belt 25 is equal to or smaller than the width of the lithium foil 61, the tension applied on the lithium foil 61 is not appropriately controlled, and a lithium sticking phenomenon may not be suppressed. Therefore, the width of belt 25 should always be formed to be greater than the width of the lithium foil 61.

A material of the belt 25 may include, for example, a polymer material In addition, the same material can be used for the roll 10 as the belt 25. Types of the polymer material may include any of polyethylene, polypropylene, vinylidene, polyolefin, and polyester, and any other material that has low adhesion to lithium and does not cause the lithium sticking phenomenon can be used.

The lithium foil 61 is transported along the belt 25 by resistance generated from a part of the belt 25 surface-contacting a lower surface of the lithium foil 61, and is finally wound on the reel 51. The reel 51 can be automatically rotated by a transporting force of the conveyor device 25 without a separate driving part.

Alternatively, the reel 51 may be driven with the driving part provided on one side for winding the lithium foil 61.

Although not shown in the drawings, if the material of the roll 10 and the belt 25 is not made of a polymer, for example, in case of using a metallic material, the rolling may be performed without the sticking phenomenon of the lithium sheet 60 by further interposing a resin film on at least one side of the lithium sheet 60 that contacts the roll 10. The resin film may include, for example, any one of polyethylene, polypropylene, vinylidene, polyolefin, and polyester.

On the other hand, the lithium rolling apparatus 200 according to an embodiment of the present disclosure may be further applied with a conveyor device or a rolling roll. This will be described later with reference to the drawings.

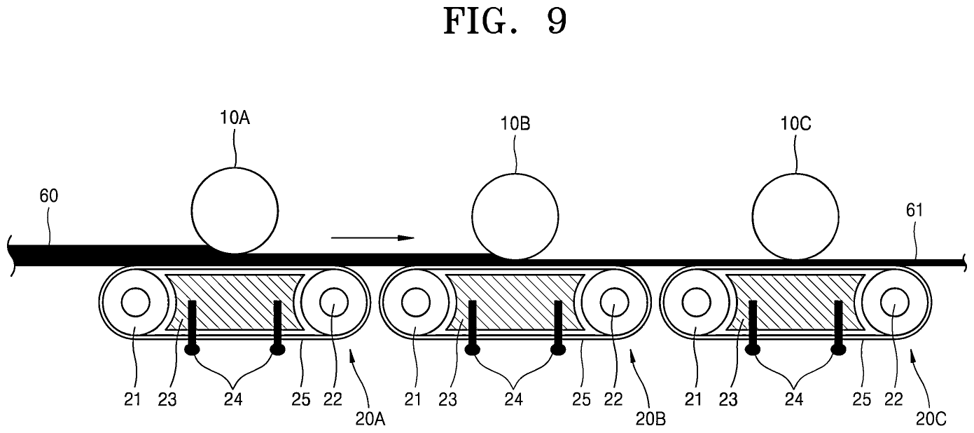

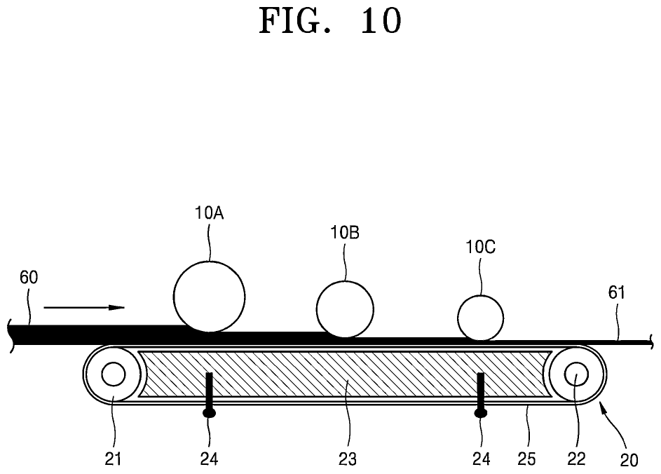

FIGS. 9 and 10 are cross-sectional views schematically illustrating a structure of a conveyor device of a lithium rolling apparatus according to another embodiment of the present disclosure.

Referring to FIG. 9, a lithium rolling apparatus 200 may have at least two or more rolling mills each including a unit of a conveyor device 20 and a roll 10 disposed continuously. Hereinafter, the rolling mill may be referred to as a conveyor device for convenience.

For example, assuming that three unit rolling mills are disposed continuously, a first conveyor device 20A, a second conveyor device 20B, and a third conveyor device 20C are disposed adjacent to each other. Here, a rolling roll configured to roll a lithium sheet 60 is provided in each of the conveyor device 20A, 20B, 20C. That is, the first conveyor device 20A in which a first roll 10A is provided, the second conveyor device 20B in which a second roll 10B is provided, and the third conveyor device 20C in which a third roll 10C is provided are arranged continuously.

Diameters of the first roll 10A, the second roll 10B, and the third roll 10C may all be in a same size. Alternatively, considering a linear velocity according to the transportation of the lithium foil 61, the diameter of the third roll 10C provided on the third conveyor device 20C disposed at the rear side may be formed smaller than the diameter of the first roll 10A provided on the first conveyor device 20A disposed at the front side.

Further, depending on a reduction ratio of rolling the lithium sheet 60, the driving speed of the third conveyor device 20C disposed at the rear side of at least two or more of the rolling mills may be controlled to be the equal speed or faster than the driving speed of the first conveyor device 20A disposed at the front side.

Although not shown in the drawings, when a plurality of rolling rolls are provided in a plurality of unit rolling mills, the plurality of rolls may have increasing diameters from the rolling rolls provided in the conveyor device disposed at the front side, to the rolling rolls provided in the conveyor device disposed at the rear side. In this case, considering the thickness of the lithium sheet 60 and a linear velocity of the lithium sheet 60 contacting the rolling rolls, each of the driving speed of the plurality of rolling rolls can be controlled differently.

Referring to FIG. 10, the lithium rolling apparatus 200 may include a plurality of rolls on one conveyor device 20.

For example, assuming that three rolls are disposed continuously on one conveyor device 20, the second roll 10B and the third roll 10C may be disposed sequentially with respect to the first roll 10A disposed at the front side where the lithium sheet 60 is inserted. Here, considering the thickness of the rolled lithium foil 61, the diameter of the third roll 10C provided at the rear side of the conveyor device 20 may be formed to be equal to or smaller than the diameter of the first roll 10A provided at the front side.

In case a plurality of rolling rolls are provided in the single conveyor device 20, the driving speed of the belt 25 that is surface-contacting the lower surface of the lithium sheet 60 is always equal. Therefore, by controlling the plurality of rolling rolls to be in different sizes, or by controlling the plurality of rolling rolls to have different driving speed, a shear stress applied to the lithium sheet 60 can be controlled to roll the lithium sheet 60.

Although not shown in the drawing, when the plurality of rolling roll is provided inside a single conveyor device 20, the plurality of rolls may have the same diameter. Alternatively, the diameter of rolling roll may become increasingly larger from the front side of the conveyor device 20 to the rear side. In this case, considering the thickness of the lithium sheet 60 and a linear velocity of the lithium sheet 60 contacting the rolling rolls, each of the driving speed of the plurality of rolling rolls can be controlled differently.

The present disclosure has been described with reference to the embodiments illustrated in the drawings, but these embodiments are merely illustrative and it should be understood by a person with ordinary skill in the art that various modifications and equivalent embodiments can be made without departing from the scope of the present disclosure. Therefore, the true technical protective scope of the present disclosure should be determined based on the technical concept of the appended claims.

1. A lithium rolling apparatus for forming a lithium foil by rolling a lithium sheet, comprising:
a first roll which contacts a first surface of the lithium sheet;
a second roll which contacts a second surface of the lithium sheet; and
a first conveyor device disposed at a rear side of the first roll and the second roll, comprising a belt which transports the lithium foil while controlling tension applied to the lithium foil by surface-contacting at least a part of the second surface of the lithium foil.

2. The lithium rolling apparatus of claim 1, comprising
a guide roll formed at a position contacting the first surface of the lithium foil on the first conveyor device so that the lithium foil can be transported in a flat manner when the lithium foil is transported by the first conveyor device.

3. The lithium rolling apparatus of claim 1, comprising
a second conveyor device disposed at an upper part of the first conveyor device, which contacts the first surface of the lithium foil and transports the lithium foil,
wherein the first conveyor device and the second conveyor device are driven at a same speed.

4. The lithium rolling apparatus of claim 1, comprising
a third conveyor device disposed at a front side of the first roll and the second roll for transporting the lithium sheet while contacting at least any part of the second surface of the lithium sheet,
wherein driving speed of the third conveyor device is controlled to be equal to or slower than driving speed of the first conveyor device.

5. The lithium rolling apparatus of claim 4, further comprising
a fourth conveyor device disposed at an upper part of the third conveyor device, which contacts the first surface of the lithium sheet and transports the lithium sheet,
wherein the third conveyor device and the fourth conveyor device are driven at a same speed.

6. The lithium rolling apparatus of claim 1, comprising
a lubricant supply part which sprays lubricant on at least any one surface of the lithium sheet before being rolled by the first roll and the second roll to suppress a sticking phenomenon.

7. The lithium rolling apparatus of claim 1,
wherein the first roll, the second roll and the belt comprises a polymer material, and the polymer material comprises any one of polyethylene, polypropylene, vinylidene, polyolefin, and polyester.

8. The lithium rolling apparatus of claim 1,
wherein a resin film is further interposed on at least any one surface of the lithium sheet contacting any one of the first roll and the second roll to prevent a sticking phenomenon.

9. The lithium rolling apparatus of claim 1,
wherein a width of the belt of the first conveyor device is greater than a width of the lithium foil, and the lithium foil is transported at a same speed as the belt by a driving force of the belt in a surface-contact state.

10. A lithium rolling method comprising:
a step of forming a lithium foil by rolling using a first roll contacting a first surface of a lithium sheet and a second roll contacting a second surface of the lithium sheet; and
a step of transporting the lithium foil with a first conveyor device disposed at a rear side of the first roll and the second roll while controlling tension applied to the lithium foil by surface-contacting at least any part of a second surface thereof with a belt provided on the first conveyor device.

11. The lithium rolling method of claim 10,
wherein when the lithium foil is transported by the first conveyor device by a guide roll formed at a position contacting the first surface of the lithium foil on the first conveyor device or by a second conveyor device, tension applied on the lithium foil is controlled, and the lithium foil is transported in a flat manner.

12. A lithium rolling apparatus for forming a lithium foil by rolling a lithium sheet, comprising:
a conveyor device for transporting and rolling the lithium sheet, and
a roll disposed at an upper part of the conveyor device for rolling the lithium sheet;
wherein the conveyor device comprises
a belt surface-contacting at least a part of a lower surface of the lithium sheet for rolling and transporting the lithium sheet while controlling tension applied on the lithium sheet, and a support part for supporting the lithium sheet.

13. The lithium rolling apparatus of claim 12,
wherein at least two or more rolling mills each comprising a unit of the conveyor device and the roll are disposed continuously, and among at least two or more of the rolling mills, a driving speed of the rolling mill disposed at a rear side is controlled to be equal to or faster than a driving speed of the rolling mill disposed at a front side.

14. The lithium rolling apparatus of claim 13,
wherein among at least two or more of the rolling mills, a diameter of the rolling mill disposed at the rear side is equal to or smaller than a diameter of the rolling mill disposed at the front side.

15. The lithium rolling apparatus of claim 12,
wherein a plurality of the rolls are provided on the conveyor device, and
a diameter of the roll disposed at a rear side of the conveyor device is equal to or smaller than a diameter of the roll disposed at the front side of the conveyor device.

16. The lithium rolling apparatus of claim 12, comprising
a lubricant supply part which sprays lubricant on at least any one surface of the lithium sheet before being rolled by the roll and the conveyor device to suppress a sticking phenomenon.

17. The lithium rolling apparatus of claim 12,
wherein a resin film is further interposed on at least any one surface of the lithium sheet contacting any one of the roll and the conveyor device to prevent a sticking phenomenon.

18. The lithium rolling apparatus of claim 12,
wherein a width of the belt of the conveyor device is greater than a width of the lithium foil, and the lithium foil is transported at a same speed as the belt by a driving force of the belt in a surface-contact state.

19. The lithium rolling apparatus of claim 12,
wherein the roll and the belt comprise a polymer material, and the polymer material comprises any one of polyethylene, polypropylene, vinylidene, polyolefin, and polyester.
